(19) United States
(12) Patent Application Publication
(10) Pub. No.: US 2008/0097062 A1
(43) Pub. Date: Apr. 24, 2008

(54) Method of Producing Disproportionated Rosin

(75) Inventors: Gangkai Zhao, Baton Rouge, LA (US); Todd Maxwell Cooke, Greenwell Springs, LA (US)

Correspondence Address: EDGAR SPIELMAN;ALBEMARLE CORPORATION, 451 FLORIDA BLVD., BATON ROUGE, LA, 70801, US

(73) Assignee: ALBEMARLE CORPORATION, BATON ROUGE, LA (US)

(21) Appl. No.: 11/814,520

(22) PCT Filed: Feb. 9, 2005
(86) PCT No.: PCT/US05/04000

§ 371 Date: Jul. 23, 2007

(51) Int. Cl. C08G 8/34

(52) U.S. Cl. 527/602

(57) ABSTRACT

This method relates to a method for the production of fully disproportionated rosin by treating rosin with sulfur and an alkylphenol sulfide compound of a particular structure.

### BACKGROUND OF THE INVENTION

(1) Field of the Invention

The present invention relates to a method of producing disproportionated rosin, in particular it relates to a method of producing fully disproportionated rosin.

(2) Description of the Related Art

Disproportionated rosin is a rosin that has been catalytically treated in order to remove conjugated double bonds and thereby increase its stability. The major chemical effect of disproportionation is the conversion of abietic acid to dehydroabietic acid.

By far the largest market for fully disproportionated rosin is in the production of the synthetic rubber used in the manufacture of tires. The disproportionated rosin, in the form of its soap, is used at a 5% by weight level as an emulsifying agent for the production of synthetic rubber, primarily styrene-butadiene rubber (SBR). Disproportionated rosin is well suited for this end use because not only is it free of double bonds that could interfere with the polymerization reaction, but it is also a rubber tackifier and so contributes to the final product. Hydrogenated rosin is also satisfactory for this end use, but hydrogenation is expensive, therefore in the present market, disproportionated rosin is the preferred product.

The classical method that is used to disproportionate rosin is the use of noble metal catalysts such as platinum or palladium. This process is expensive, because of the requirement that the catalyst must be reactivated, which requires removal from the reaction system, and often requires sending the catalyst to another location. In the United States, where tall oil rosin is normally used, the use of noble metal catalysts is even less attractive due to the presence of sulfur-based impurities in the rosin, which reduce the efficiency of the catalyst. Consequently, new catalyst systems were developed and are now widely used in the United States. These new catalysts are primarily blends of iodine and sulfur. Even though iodine is corrosive and sulfur can leave an objectionable odor in the product, the use of these catalysts for rosin disproportionation is well established in the United States.

In China, where gum rosin is the most available rosin, the noble metal catalysts are still used. However, pressure for increased efficiency at reduced expense is increasing in that market also.

In the prior art, a number of different schemes have been reported for the disproportionation of rosin acids. For example, In U.S. Pat. No. 6,087,318, Jadhav described a process for disproportionating rosin using iodide catalysts. Ferrous iodide and/or lithium iodide were used as catalyst to disproportionate tall oil rosin. Phosphoric acid could be added to remove impurities.

Correia, in U.S. Pat. No. 4,659,513, described the disproportionation of rosin or tall oil by heating rosin with a catalyst comprising iodine, an iron compound, and ammonia, an ammonium salt, or an amine. Pretreatment of the rosin by heating it with not over 0.5% by weight elemental sulfur at 250° C. to 270° C. was optional.

In U.S. Pat. No. 3,943,118, Lehtinen described a method for disproportionating rosin acids which contain a conjugated diene structure by contacting them with sulfur and/or iodine at a raised temperature.

U.S. Pat. No. 3,377,334 describes the disproportionation of rosins by heating the rosin in the presence of a phenol sulfide compound such as 2-2′-thiobis(4-methyl-6-t-butylphenol). U.S. Pat. No. 3,423,389 describes the use of the same type of phenol sulfide compounds for lightening the color of a rosin without reducing the abietic acid concentration to less than 15%. A similar method for rosin disproportionation is described in U.S. Pat. No. 3,649,612, where aryl thiols are used in place of the phenol sulfide compounds.

In U.S. Pat. No. 3,872,073, Thorpe et al. described the disproportionation of rosin by heating the rosin at temperatures between 250° C. and 275° C. in the presence of specific phenol sulfides, such as 1-thio-2-naphthol, 1,1′-di-(2-naphthol)-disulfide, and 1.1′-di(2-naphthol)-sulfide.

Also, Breslow, in U.S. Pat. No. 4,265,807, described the disproportionation of rosin in the presence of dithiin derivatives, such as 2,5-diphenyl dithiin.

In U.S. Pat. No. 3,417,071, Wheelus described the use of 1,3,4-thiadiazole polysulfides for bleaching and stabilizing tall oil rosin and derivatives. In U.S. Pat. No. 3,423,389, the same inventor described the production of rosin compounds of improved color and stability by heating them in the presence of a phenol sulfide compound. Examples of such compounds included 2.2′-thiobis(4-methyl-6-t-butylphenol), 4,4′-thiobis(resorcinol), and 2.2′-thiobis(4,6-dimethylphenol). In U.S. Pat. No. 3,377,334, McBride and Wheelus described the use of the same type of phenol sulfide compounds for disproportionation of rosin. Starting materials were tall oil rosin, wood rosin, gum rosin crude materials and mixtures of these materials. In the process described, abietic acid level was reduced to less than 15% by heating the rosin at a temperature of about 180° C. to 350° C. in the presence of 0.01% to 1% of a phenol sulfide compound. A similar process is described in U.S. Pat. No. 3,649,612 to Scharrer, except that an aryl thiol was used as the disproportionation catalyst rather than a phenol sulfide compound.

Despite the significant prior work that has been expended in the development of processes to produce fully disproportionated rosin, it would still be useful to provide a process by which a rosin of almost any sort could be fully disproportionated easily and efficiently, and it would be even more useful if such process could be provided that could produce fully disproportionated rosin having a level of dehydroabietic acid, and values of softening point, color, and acid number, which met the normal and conventional specifications for regular grade, and even premium grade, disproportionated rosin. It would also be useful if such a process could be provided that avoided the corrosive effects of iodine.

### SUMMARY OF THE INVENTION

Briefly, therefore, the present method is directed to a novel method of producing fully disproportionated rosin, the method comprising: contacting rosin with sulfur to form a partially disproportionated rosin; and contacting the partially disproportionated rosin with an alkylphenol sulfide compound having the structure 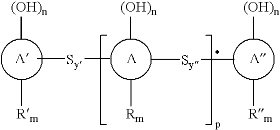
where:
each of A, A′ and A″ is independently an aryl;
each n is independently 1, 2, or 3;
each of y′ and y″ is independently 0, 1, 2, or 3;
the sum of m and n on each aryl is 1, 2, 3, 4, or 5;
p is an integer from 0 to 100 inclusive; and
each of R, R′ and R″ is independently a hydrocarbon group,
to form a fully disproportionated rosin.

The present invention is also directed to a novel fully disproportionated rosin that is made by the method described above.

Among the several advantages found to be achieved by the present invention, therefore, may be noted the provision of a process by which a rosin of almost any sort can be fully disproportionated easily and efficiently, the provision of such a process that can produce fully disproportionated rosin having a level of dehydroabietic acid, and values of softening point, color, and acid number, which meets the normal and conventional specifications for regular grade, and even premium grade, disproportionated rosin, and the provision of such a process that avoids the corrosive effects of iodine.

### DETAILED DESCRIPTION OF THE PREFERRED EMBODIMENTS

In accordance with the present invention, it has been discovered that rosin can be fully disproportionated by treatment with sulfur and an alkylphenol sulfide compound. It was found to be preferred that the rosin is first treated with sulfur and then the sulfur-treated rosin is treated with an alkylphenol sulfide compound. The present method provides several advantages over methods for rosin disproportionation that are now known. For example, the novel method results in the production of a fully disproportionated rosin having a level of abietic acid that is no higher than 0.5% by wt., and which can even be as low as 0.1% by wt., or even lower. Moreover, such low levels of abietic acid can be produced while maintaining high acid number and softening point values. Rosins with an acid number of at least about 150, 152, or even 155 can be provided, and which have a softening point of over 75° C. These high-quality fully disproportionated rosins can be produced in a simple, one-reactor system, if desired. Furthermore, the products can be further improved by an optional vacuum treatment or steam stripping at the end of the reaction process to reduce or remove residual hydrogen sulfide and light oils. This optional treatment can improve the acid number and/or the softening point of the rosin, and can improve the odor of the rosin as well.

The present method is useful for the disproportionation of almost any type of rosin. It is preferred that the rosin be a product of a pine tree (Pinus spp.) and that it contains one or more rosin acids, which include but are not limited to neoabietic acid, abietic acid, dehydroabietic acid, levoprimaric acid, and primaric acid. It is more preferred that the rosin acids listed above make up at least 15% of the rosin, even more preferred that they make up at least about 25% of the rosin, and yet more preferred that they make up at least about 50% of the rosin. Examples of rosins (which may or may not be pine tree constituents) that are useful in the present invention include tall oil rosin, wood rosin, gum rosin, crude materials containing these rosins, and mixtures of any two or more of these. Of these, tall oil rosin, wood rosin, and gum rosin are preferred for use in the present method.

When the rosin is contacted with sulfur, it is preferred that the reaction is carried out under conditions that will result in the formation of a partially disproportionated rosin. When it is said that rosin is partially disproportionated, it is meant that the rosin has received some treatment that reduced the content of one or more rosin acid. It is preferred that the abietic acid content of the rosin is reduced and that the abietic acid content of partially disproportionated rosin has been reduced to a level not lower than about 1% by weight, even more preferred is not lower than about 5%, yet more preferred is not lower than about 10%, and even more preferred that the abietic acid content is not be lower than about 15%, all by weight. In contrast, when it is said that a rosin is fully disproportionated, it is meant that the rosin has an abietic acid content that is lower than about 1% by weight, preferably lower than about 0.5% by weight, and more preferably, lower than about 0.1% by weight.

In the present method, it is preferred that the rosin is charged to a reactor vessel that is constructed of inert materials. Glass and stainless steel are preferred, but other non-corrosive metals and composites can also be used. The reactor can be of any size, but should have capabilities for heating and temperature control of the contents between room temperature and about 350° C. The reactor should also have an agitator that is capable of mixing molten rosin. A propeller or turbine impeller on a shaft is usually suitable for such service. In addition, the reactor should have a vent that is channeled through a condenser. The condenser can be a water-cooled condenser. The reactor should also have provisions for filling the head-space of the reactor with an inert gas, such as nitrogen, neon, argon, steam, or the like, while the reactor contains molten rosin.

The reactor is charged with the desired amount of rosin and the head space of the reactor is filled with an inert gas, usually nitrogen. The rosin is heated to melting and when all of the rosin is melted, agitation is started. The temperature at this point can be about 200° C.

The temperature of the molten rosin charge in the reactor is adjusted to the temperature desired for the first stage of the treatment process (the first temperature, or first stage temperature). When the desired temperature is reached, sulfur is added to the rosin. Although almost any source of relatively pure sulfur can be used for the process, the use of elemental sulfur of commercial grade is preferred, and the use of elemental sulfur powder of commercial grade is more preferred. After the addition of sulfur, agitation is continued and the temperature of the reactor contents are maintained for a desired length of time. In practice, it is preferred that the amount of sulfur that is added, the temperature of the rosin, and the length of time that is allowed for the reaction of the rosin with sulfur, are controlled to provide a partially disproportionated rosin without reducing the acid number or the softening point to values that are below those that are acceptable in the fully disproportionated rosin, and without increasing the color to an unacceptable level.

The amount of sulfur that is added to the rosin is between about 0.5% and about 10% by weight based on the weight of the rosin, and the sulfur is contacted with the rosin for a period of from about 0.5 hrs to about 10 hrs at a temperature that is between about 200° C. and about 325° C. It is preferred that the amount of sulfur is between about 1% and about 5% by weight based on the weight of the rosin, and the sulfur is contacted with the rosin for a period of from about 1 hrs to about 5 hrs at a temperature that is between about 225° C. and about 275° C., more preferred that the amount of sulfur is between about 2% and about 3% by weight based on the weight of the rosin, and the sulfur is contacted with the rosin for a period of from about 1 hrs to about 3 hrs at a temperature that is between about 230° C. and about 250° C., yet more preferred the amount of sulfur is about 2.5% by weight based on the weight of the rosin, and the sulfur is contacted with the rosin for a period of from about 2 hrs to 3 hrs at a temperature that is about 240° C.

When sulfur is added to the molten rosin, it is not unusual for hydrogen sulfide gas to evolve. This gas can be scrubbed from the vent of the reactor by channeling the vent gas through an aqueous scrubbing solution comprising about 25% caustic.

After the rosin has been reacted in the presence of sulfur for a time sufficient to partially disproportionate the rosin, the temperature is adjusted to a second stage level, and the alkylphenol sulfide compound is added to the reactor contents.

In the present method, the alkylphenol sulfide is a compound having the structure: 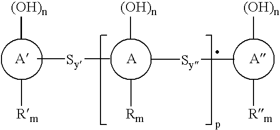
where:
each of A, A′ and A″ is independently an aryl;
each n is independently 1, 2, or 3;
each of y′ and y″ is independently 0, 1, 2, or 3;
the sum of m and n on each aryl is 1, 2, 3, 4, or 5;
p is an integer from 0 to 100 inclusive; and
each of R, R′ and R″ is independently a hydrocarbon group;
including the isomers, racemates, and salts thereof.

The meaning of any substituent at any one occurrence in any general chemical formula herein is independent of its meaning, or any other substituent's meaning, at any other occurrence, unless specified otherwise.

The term “hydrocarbon group” embraces any substituent group that contains exclusively hydrogen and carbon.

The term “alkyl” is used, either alone or within other terms such as “haloalkyl” and “alkylsulfonyl”; it embraces linear or branched radicals having one to about twenty carbon atoms or, preferably, one to about twelve carbon atoms. More preferred alkyl radicals are “lower alkyl” radicals having one to about ten carbon atoms. Most preferred are lower alkyl radicals having one to about five carbon atoms. The number of carbon atoms can also be expressed as “C₁-C₅”, for example. Examples of such radicals include methyl, ethyl, n-propyl, isopropyl, n-butyl, isobutyl, sec-butyl, tert-butyl, pentyl, isoamyl, hexyl, octyl and the, like. The term “alkenyl” refers to an unsaturated, acyclic hydrocarbon radical, linear or branched, in so much as it contains at least one double bond. Unless otherwise noted, such radicals preferably contain from 2 to about 6 carbon atoms, preferably from 2 to about 4 carbon atoms, more preferably from 2 to about 3 carbon atoms. The alkenyl radicals may be optionally substituted with groups as defined below. Examples of suitable alkenyl radicals include propenyl, 2-chloropropylenyl, buten-1-yl, isobutenyl, penten-1yl, 2-methylbuten-1-yl, 3-methylbuten-1-yl, hexen-1-yl, 3-hydroxyhexen-1-yl, hepten-1-yl, octen-1-yl, and the like. The term “alkynyl” refers to an unsaturated, acyclic hydrocarbon radical, linear or branched, in so much as it contains one or more triple bonds, such radicals preferably containing 2 to about 6 carbon atoms, more preferably from 2 to about 3 carbon atoms. The alkynyl radicals may be optionally substituted with groups as described below. Examples of suitable alkynyl radicals include ethynyl, proynyl, hydroxypropynyl, butyn-1-yl, butyn-2-yl, pentyn-1-yl, pentyn-2-yl, 4-methoxypentyn-2-yl, 3-methylbutyn-1-yl, hexyl-1-yl, hexyn-2-yl, hexyn-3-yl, 3,3-dimethylbutyn-1-yl radicals, and the like.

The term “oxo” means a single double-bonded oxygen. The terms “hydrido”, “—H”, or “hydrogen”, denote a single hydrogen atom (H). This hydrido radical may be attached, for example, to an oxygen atom to form a hydroxyl radical, or two hydrido radicals may be attached to a carbon atom to form a methylene (—CH₂—) radical.

The term “halo” means halogens such as fluorine, chlorine, and bromine or iodine atoms. The term “haloalkyl” embraces radicals wherein any one or more of the alkyl carbon atoms is substituted with halo as defined above. Specifically embraced are monohaloalkyl, dihaloalkyl, and polyhaloalkyl radicals. A monohaloalkyl radical, for one example, may have a bromo, chloro, or a fluoro atom within the radical. Dihalo radicals may have two or more of the same halo atoms or a combination of different halo radicals and polyhaloalkyl radicals may have more than two of the same halo atoms or a combination of different halo radicals. Likewise, the term “halo”, when it is appended to alkenyl, alkynyl, alkoxy, aryl, cycloalkyl, heteroalkyl, heteroaryl, and the like, includes radicals having mono-, di-, or tri-, halo substitution on one or more of the atoms of the radical.

The term “hydroxyalkyl” embraces linear or branched alkyl radicals having one to about ten carbon atoms any one of which may be substituted with one or more hydroxyl radicals.

The terms “alkoxy” and “alkoxyalkyl” embrace linear or branched oxy-containing radicals each having alkyl portions of one to about ten carbon atoms, such as methoxy radical. The term “alkoxyalkyl” also embraces alkyl radicals having two or more alkoxy radicals attached to the alkyl radical, that is, to form monoalkoxyalkyl and dialkoxyalkyl radicals. The “alkoxy” or “alkoxyalkyl” radicals may be further substituted with one or more halo atoms, such as fluoro, chloro, or bromo, to provide “haloalkoxy” or “haloalkoxyalkyl” radicals. Examples of “alkoxy” radicals include methoxy, butoxy, and trifluoromethoxy. Terms such as “alkoxy(halo)alkyl”, indicate a molecule having a terminal alkoxy that is bound to an alkyl, which is bonded to the parent molecule, while the alkyl also has a substituent halo group in a non-terminal location. In other words, both the alkoxy and the halo group are substituents of the alkyl chain.

The term “aryl”, alone or in combination, means a carbocyclic aromatic system containing one, two, or three rings wherein such rings may be attached together in a pendent manner or may be fused. The term “aryl” embraces aromatic radicals such as phenyl, naphthyl, tetrahydronapthyl, indane, and biphenyl. The term “heterocyclyl” means a saturated or unsaturated mono- or multi-ring carbocycle wherein one or more carbon atoms is replaced by N, S, P, or O. This includes, for example, structures such as: 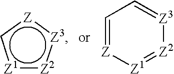
where Z, Z¹, Z², or Z³ is C, S, P, O, or N, with the proviso that one of Z, Z¹, Z², or Z³ is other than carbon, but is not O or S when attached to another Z atom by a double bond or when attached to another O or S atom. Furthermore, the optional substituents are understood to be attached to Z, Z¹, Z², or Z³ only when each is C. The term “heterocycle” also includes fully saturated ring structures, such as piperazinyl, dioxanyl, tetrahydrofuranyl, oxiranyl, aziridinyl, morpholinyl, pyrrolidinyl, piperidinyl, thiazolidinyl, and others. The term “heteroaryl” embraces unsaturated heterocyclic radicals. Examples of unsaturated heterocyclic radicals, also termed “heteroaryl” radicals include thienyl, pyrryl, furyl, pyridyl, pyrimidyl, pyrazinyl, pyrazolyl, oxazolyl, isoxazolyl, imidazolyl, thiazolyl, pyranyl, and tetrazolyl. The term also embraces radicals where heterocyclic radicals are fused with aryl radicals. Examples of such fused bicyclic radicals include benzofuran, benzothiophene, and the like. The terms aryl or heteroaryl, as appropriate, include the following structures: 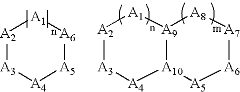
where:
when n=1, m=1 and A₁-A₈ are each CR^{x} or N, A₉ and A₁₀ are carbon; when n=0, or 1, and m=0, or 1, one of A₂-A₄ and/or A₅-A₇ is optionally S, O, or NR^{x}, and other ring members are CR^{x} or N, with the proviso that oxygen cannot be adjacent to sulfur in a ring. A₉ and A₁₀ are carbon;
when n is greater than or equal to 0, and m is greater than or equal to 0, 1 or more sets of 2 or more adjacent atoms A₁-A₁₀ are sp3 O, S, NR^{x}, CR^{x}R^{y}, or C═(O or S), with the proviso that oxygen and sulfur cannot be adjacent. The remaining A₁-A₈ are CR^{x} or N, and A₉ and A₁₀ are carbon;
when n is greater than or equal to 0, and m is greater than or equal to 0, atoms separated by 2 atoms (i.e., A₁ and A₄) are sp3 O, S, NR^{x}, CR^{x}R^{y}, and remaining A₁-A₈ are independently CR^{x} or N, and A₉ and A₁₀ are carbon.

In either, “heterocyclyl” or “heteroaryl”, the point of attachment to the molecule of interest can be at the heteroatom or elsewhere within the ring.

The term “cycloalkyl” means a mono- or multi-ringed carbocycle wherein each ring contains three to about ten carbon atoms, preferably three to about six carbon atoms, and more preferably three to about five carbon atoms. Examples include radicals, such as cyclopropyl, cyclobutyl, cyclopentyl, cyclohexyl, cycloalkenyl, and cycloheptyl. The term “cycloalkyl” additionally encompasses spiro systems wherein the cycloalkyl ring has a carbon ring atom in common with the seven-membered heterocyclic ring of the benzothiepine. The term “cycloalkenyl” embraces unsaturated radicals having three to ten carbon atoms, such as cylopropenyl, cyclobutenyl, cyclopentenyl, cyclohexenyl, and cycloheptenyl.

The term “sulfonyl”, whether used alone or linked to other terms such as alkylsulfonyl, denotes respectively divalent radicals —SO₂—. “Alkylsulfonyl”, embraces alkyl radicals attached to a sulfonyl radical, where alkyl is defined as above. The term “arylsulfonyl” embraces sulfonyl radicals substituted with an aryl radical. The terms “sulfamyl” or “sulfonamidyl”, whether alone or used with terms such as “N-alkylsulfamyl”, “N-arylsulfamyl”, “N,N-dialkylsulfamyl” and “N-alkyl-N-arylsulfamyl”, denotes a sulfonyl radical substituted with an amine radical, forming a sulfonamide (—SO₂—NH₂), which may also be termed an “aminosulfonyl”. The terms “N-alkylsulfamyl” and “N,N-dialkylsulfamyl” denote sulfamyl radicals substituted, respectively, with one alkyl radical, a cycloalkyl ring, or two alkyl radicals. The terms “N-arylsulfamyl” and “N-alkyl-N-arylsulfamyl” denote sulfamyl radicals substituted, respectively, with one aryl radical, and one alkyl and one aryl radical.

The terms “carboxy” or “carboxyl”, whether used alone or with other terms, such as “carboxyalkyl”, denotes —CO₂—H. The term “carboxyalkyl” embraces radicals having a carboxyradical as defined above, attached to an alkyl radical. The term “carbonyl”, whether used alone or with other terms, such as “alkylcarbonyl”, denotes —(C═O)—. The term “alkylcarbonyl” embraces radicals having a carbonyl radical substituted with an alkyl radical. An example of an “alkylcarbonyl” radical is CH₃—(CO)—. The term “alkylcarbonylalkyl” denotes an alkyl radical substituted with an “alkylcarbonyl” radical. The term “alkoxycarbonyl” means a radical containing an alkoxy radical, as defined above, attached via an oxygen atom to a carbonyl (C═O) radical. Examples of such “alkoxycarbonyl” radicals include (CH₃)₃—C—O—C═O)— and —(O═)C—OCH₃. The term “alkoxycarbonylalkyl” embraces radicals having “alkoxycarbonyl”, as defined above substituted to an alkyl radical. Examples of such “alkoxycarbonylalkyl” radicals include (CH₃)₃C—OC(═O)—(CH₂)₂— and —(CH₂)₂(—O)COCH₃. The terms “amido”, or “carbamyl”, when used alone or with other terms such as “amidoalkyl”, “N-monoalkylamido”, “N-monoarylamido”, “N,N-dialkylamido”, “N-alkyl-N-arylamido”, “N-alkyl-N-hydroxyamido” and “N-alkyl-N-hydroxyamidoalkyl”, embraces a carbonyl radical substituted with an amino radical. The terms “N-alkylamido” and “N,N-dialkylamido” denote amido groups which have been substituted with one alkylradical and with two alkyl radicals, respectively. The terms “N-monoarylamido” and “N-alkyl-N-arylamido” denote amido radicals substituted, respectively, with one aryl radical, and one alkyl and one aryl radical. The term “N-alkyl-N-hydroxyamido” embraces amido radicals substituted with a hydroxyl radical and with an alkyl radical. The term “N-alkyl-N-hydroxyamidoalkyl” embraces alkylradicals substituted with an N-alkyl-N-hydroxyamido radical. The term “amidoalkyl” embraces alkyl radicals substituted with amido radicals. The term “aminoalkyl” embraces alkyl radicals substituted with amino radicals. The term “alkylaminoalkyl” embraces aminoalkyl radicals having the nitrogen atom substituted with an alkyl radical. The term “amidino” denotes an —C(—NH)—NH₂ radical. The term “cyanoamidin” denotes an —C(—N—CN)—NH₂ radical. The term “heterocycloalkyl” embraces heterocyclic-substituted alkyl radicals such as pyridylmethyl and thienylmethyl.

The terms “aralkyl”, or “arylalkyl” embrace aryl-substituted alkyl radicals such as benzyl, diphenylmethyl, triphenylmethyl, phenethyl, and diphenethyl. The terms benzyl and phenylmethyl are interchangeable. The term “alkylthio” embraces radicals containing a linear or branched alkyl radical, of one to ten carbon atoms, attached to a divalent sulfur atom. An example of “alkylthio” is methylthio, (CH₃—S—). The term “alkylsulfinyl” embraces radicals containing a linear or branched alkyl radical, of one to ten carbon atoms, attached to a divalent —S(—O)— atom. The terms “N-alkylamino” and “N,N-dialkylamino” denote amino groups which have been substituted with one alkyl radical and with two alkyl radicals, respectively.

The term “acyl”, whether used alone, or within a term such as “acylamino”, denotes a radical provided by the residue after removal of hydroxyl from an organic acid. The term “acylamino” embraces an amino radical substituted with an acyl group. An examples of an “acylamino” radical is acetylamino (CH₃—C(═O)—NH—).

In the naming of substituent groups for general chemical structures, the naming of the chemical components of the group is typically from the terminal group-toward the parent compound unless otherwise noted, as discussed below. In other words, the outermost chemical structure is named first, followed by the next structure in line, followed by the next, etc. until the structure that is connected to the parent structure is named. For example, a substituent group having a structure such as: 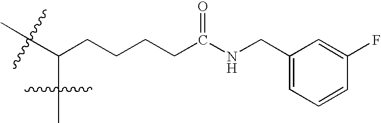
may be referred to generally as a “haloarylalkylaminocarbonylalkyl”. An example of one such group would be fluorophenylmethylcarbamylpentyl. The bonds having wavy lines through them represent the parent structure to which the alkyl is attached.

Substituent groups may also be named by reference to one or more “R” groups. The structure shown above would be included in a description, such as, “—C₁-C₆-alkyl-COR^{u}, where R^{u} is defined to include —NH—C₁-C₄-alkylaryl-R^{y}, and where R^{y} is defined to include halo. In this scheme, atoms having an “R” group are shown with the “R” group being the terminal group (i.e., furthest from the parent). In a term such as “C(R^{x})₂”, it should be understood that the two R^{x} groups can be the same, or they can be different if R^{x} is defined as having more than one possible identity.

In an embodiment of the present invention, the alkylphenol sulfide is one wherein A, A′ and A″ are the same and are selected from phenyl, naphthyl, or anthracyl.

In a preferred embodiment, the alkylphenol sulfide is one wherein each of R, R′ and R″ is independently a substituted or unsubstituted alkyl, or cycloalkyl, which if substituted, has substituent groups selected from cycloalkyl, aryl, or alkaryl.

It is further preferred that the alkylphenol sulfide is one wherein each of R, R′ and R″ is independently an alkyl of from 1 to 22 carbon atoms.

It is even more preferred that the alkylphenol sulfide compound is one where:

A, A′ and A″ are each phenyl;

each m and each n is 1;

each of y′ and y″ is independently 0, 1, 2, or 3;

p is 0, 1, or 2; and

each R, R′ and R″ is nonyl.

An alkylphenol sulfide of this type is commercially available from Albemarle Chemical Company, Baton Rouge, La., under the trade name Ethanox® 323.

In certain embodiments, such alkylphenol sulfide compounds as described just above may not be immediately available, or may be otherwise impossible or undesirable to procure or use, and in these circumstances, it is preferred that the alkylphenol sulfide compound of the present invention be one wherein at least one of R, R′, or R″ is other than nonyl when A, A′, and A″ are each phenyl, or wherein at least one of A, A′ and A″ are other than phenyl.

In order to complete the second stage of the present reaction scheme, a desired amount of the alkylphenol sulfide compound is added to the partially disproportionated rosin while the rosin is being agitated and remains under an inert gas blanket. The alkylphenol sulfide compound and the rosin is allowed to react at a controlled temperature for a given length of time.

In the second stage, it is preferred that the amount of the alkylphenol sulfide compound is between about 0.1% and 15% by weight based on the weight of the rosin, and the compound is contacted with the partially disproportionated rosin for a period of from about 1 hour to about 10 hours at a temperature that is between about 200° C. and 350° C. It is more preferred that the amount of the alkylphenol sulfide compound is between about 0.5% and 1.5% by weight based on the weight of the rosin, and the compound is contacted with the partially disproportionated rosin for a period of from about 2 hours to about 5 hours at a temperature that is between about 240° C. and 300° C., and yet more preferred that the amount of the alkylphenol sulfide compound is about 1% by weight based on the weight of the rosin, and the compound is contacted with the partially disproportionated rosin for a period of about 3 hours to 4 hours at a temperature that is about 280° C.

At the end of the second stage of the method (contacting with the alkylphenol sulfide compound), it is desirable that the fully disproportionated rosin has a concentration of abietic acid of equal to or less than 0.5% by weight, a concentration of dehydroabietic acid of equal to or more than 45% by weight, an acid value of equal to or greater than 150 mg KOH/g rosin, and a softening point of equal to or greater than 75° C. It is more preferred, however, that the fully disproportionated rosin has a concentration of abietic acid of equal to or less than 0.1% by weight, a concentration of dehydroabietic acid of equal to or more than 52% by weight, an acid value of equal to or greater than 155 mg KOH/g rosin, and a softening point of equal to or greater than 75° C.

When the first and second stage reactions are completed to the extent that is desired, it is sometimes useful to reduce or remove residual hydrogen sulfide and/or light oils that have been formed during the reaction. Removal of these components can result in an increase in the acid number of the rosin, and also in an increase in the softening point value. Although the hydrogen sulfide and/or light oils can be removed from the rosin by any of several know methods, they can advantageously be removed by applying a vacuum of about 20″-30″ Hg to the rosin at a temperature of about 240° C. for a period of from about 1 to about 3 hours, or by steam stripping these compounds from the rosin.

For some applications, it may also be desirable to bleach the fully disproportionated rosin in order to improve the color. Bleaching can be done by any of the several bleaching techniques that are well known in the art.

When it is desired to produce fully disproportionated gum rosin, the present method can be carried out as follows:

a. Gum rosin is placed into a reactor under a nitrogen blanket and heated to 200° C.;

b. When the rosin is totally melted, agitation is started—nitrogen blanketing is maintained throughout the process;

c. Sulfur is added gradually to the rosin in the reactor in an amount of 2.5% by weight based on the weight of the rosin;

d. The temperature of the rosin is increased to 240° C. and held there for 3 hours;

e. The temperature of the rosin is increased to 280° C., and Ethanox® 323 or a similar product is added in an amount of 1% by weight based on the weight of the rosin;

f. The temperature is held at 280° for 3 hours;

g. The temperature of the rosin is cooled to 240° C. and a vacuum of 20″-25″ Hg is pulled on the head-space of the reactor for 1 hour. Hydrogen sulfide and light oil content of the rosin are reduced.

h. The rosin is cooled to 200° C. and the fully disproportionated rosin is removed from the reactor.

The properties of the fully disproportionated rosin that is produced by this method are:

| | |
|---|---|
| Neoabietic acid (GC area %) | 0.08 |
| Abietic acid (GC area %) | 0.07 |
| Dehydroabietic acid (GC area %) | 70.86 |
| Levoprimaric acid (GC area %) | 5.37 |
| Primaric acid (GC area %) | 0.08 |
| Acid number | 156.8 |
| Softening point | 87.5° C. |
| Gardner color (neat rosin) | 11 |

This product compares very well with present commercial fully disproportionated rosins. By way of example, the properties of two commercially available fully disproportionated rosins are shown in Table 1.

TABLE 1
Properties of commercial fully disproportionated rosins.

| | Disproportionated | Disproportionated |
|---|---|---|
| | Rosin 1 | Rosin 2 |
| Neoabietic acid (GC area %) | 0.05 | 0.14 |
| Abietic acid (GC area %) | 0.22 | 0.13 |
| Dehydroabietic acid (GC area %) | 69.47 | 58.91 |
| Levoprimaric acid (GC area %) | 6.72 | 8 |
| Primaric acid (GC area %) | 1.25 | 0.58 |
| Acid number | 157 | 161 |
| Softening point | 78° C. | 74° C. |

Fully disproportionated rosin that is produced by the present method can be used for any application for which any other commercially available fully disproportionated rosin can be used. It can be stored, handled, transported and bought and sold in the same manner as any other fully disproportionated rosin. Likewise, the same safety measures should be taken with rosin that is the product of the present method as are appropriate for any other fully disproportionated rosin.

The following examples describe preferred embodiments of the invention. Other embodiments within the scope of the claims herein will be apparent to one skilled in the art from consideration of the specification or practice of the invention as disclosed herein. It is intended that the specification, together with the examples, be considered to be exemplary only, with the scope and spirit of the invention being indicated by the claims which follow the examples. In the examples all percentages are given on a weight basis unless otherwise indicated.

### General Procedure for the Disproportionation Reaction

This example illustrates the general procedure that was used for the disproportionation of rosin.

Rosin was placed into a 2 liter round-bottom flask having 4 necks/outlets. Only chunks or pieces of rosin were used, and any powdered rosin was discarded. The four outlets of the flask, respectively, were fitted with (1) a temperature measurement and control thermometer, (2) a water-cooled condenser with vent to atmosphere, (3) a stirring shaft with blade impeller, and (4) a connection for the introduction of a stream of nitrogen gas to blanket the reaction and fill the head space of the flask. Reactants added after the start of the reaction were added by temporarily removing the nitrogen connection, introducing the reactants to the flask through that outlet, and reconnecting the nitrogen purge line to plug the outlet.

After the reaction was begun, samples were taken of the flask contents at routine intervals. Typically, color, acid number and softening point were measured immediately, and samples were later analyzed by gas chromatographic analysis to determine rosin acid content and, hence, the degree of disproportionation.

In a typical run, 1000 grams of rosin was broken up and added to the flask. A nitrogen blanket was established in the head space of the flask and the contents of the flask were heated to the designated starting temperature. Agitation was started and stirrer speed was normally 100 rpm. Normally, when the rosin temperature reached the designated starting temperature, a sample of rosin was taken for analysis and the desired disproportionation catalyst was added at that time, or at a later time. After that point, samples were taken of the flask contents ever hour or every two hours, and further reactants were added and temperature adjustments were made as desired.

Measurement of Color:

Color was measured according to ASTM D1544, “Test Method Color of Transparent Liquids (Gardner Color Scale)”, as modified in ASTM D6166, “Color of Naval Stores and Related Products (Instrumental Determination of Gardner Color”). The Gardner Color scale runs from 1 to 18, with 1 being the lightest color and 18 being the darkest.

Measurement of Acid Number:

The acid number of rosin was measured according to ASTM Method D465-01, titled “Standard Test Methods for Acid Number of Naval Stores Products Including Tall Oil and Other Related Products”, and reported as mg KOH/gm.

Measurement of Softening Point:

The softening point of a rosin was measured according to ASTM Method E28-99 (2004), titled “Standard Test Methods for Softening Point of Resins Derived from Naval Stores by Ring-and-Ball Apparatus”, and reported as softening point in degrees Centigrade.

Measurement of Rosin Acid Content:

The rosin acid content was measured by a gas chromatographic (GC) method. The conditions used for the GC method were as follows:

Instrument: HP 5890 GC; FID detector; HP-1 capillary column; 0.20 mm i.d.; fused silica; 25 m length.

Flow rate: 10-15 psi head on column.

Gas: Helium.

Temperature gradient: 250°-300° C. at 5° C./min.

Sample preparation: Place 0.030 g of rosin sample in a 3.0 ml reacti-vial. Add 0.5 ml of Methyl 8 reagent by syringe. Add a stir bar and cap the vial. Warm the vial with stirring on a steam bath (or heating block set to 100° C.) for 30 min. Cool the vial to room temperature and inject approximately 0.2 microliters of the sample into the GC.

### COMPARATIVE EXAMPLES 1-7

These examples illustrate the results of the disproportionation reaction at different temperatures and with and without the use of the antioxidant Ethanox® 323 as a catalyst.

Chinese gum rosin from three different sources was used. These materials are identified as Rosin 1, Rosin 2, and Rosin 3. The rosin samples were loaded into the reactor and heated as described in the General Procedure. When the rosin reached the desired starting temperature, Ethanox® 323 (available from Albemarle Chemical Co., Baton Rouge, La.) was added to the molten rosin at the temperatures, times, and in the amounts noted. Blanks were run with no added Ethanox® 323. At the intervals noted in Table 3, samples were taken of the flask contents and values were determined for acid number, softening point, Gardner color, and rosin acids, as described in the General Procedure. Those values are reported below in Table 3.

TABLE 2
Conditions for rosin disproportionation with and without Ethanox ® 323

| | | First Stage | | | | | |
|---|---|---|---|---|---|---|---|
| | | | | Time of cat. | Second Stage | | |
| Example | | Temp. | Catalyst & | addition | Temp. | Catalyst & | Time of cat. |
| Number | Rosin | (° C.) | Amount | interval | (° C.) | Amount | addition |
| 1 | Rosin 1 | 240 | None | — | — | none | — |
| 2 | Rosin 1 | 240 | Ethanox 323 @ 4% | 30 min. | — | none | — |
| 3 | Rosin 1 | 260 | None | — | — | none | — |
| 4 | Rosin 1 | 260 | Ethanox 323 @ 2.76% | 30 min. | — | none | — |
| 5 | Rosin 1 | 280 | Ethanox 323 @ 2.59% | 15 min. | — | none | — |
| 6 | Rosin 2 | 280 | Ethanox 323 @ 1.5% | At start | — | none | — |
| 7 | Rosin 3 | 280 | Ethanox 323 @ 1% | At start | — | none | — |

TABLE 3
Results of disproportionation reactions run under the conditions specified in Table 2.

| Example | | | | | | | | |
|---|---|---|---|---|---|---|---|---|
| No. and | | | | | | | | |
| sample | Rosin acids (Percent by weight) | | | | | Acid | Softening | Gardner |
| time (hr) | Neo-abietic | Abietic | Dehydro-abietic | Levo-primaric | Primaric | number | point (° C.) | Color |
| Comp. Ex. 1 | | | | | | | | |
| 0 hr | 7.59 | 52.46 | 5.46 | 14.79 | 7.45 | 169.3 | 75 | 10 |
| 1 hr | 5.94 | 51.99 | 6.04 | 15.19 | 6.78 | n/a | 75 | 9 |
| 2 hr | 5.76 | 50.82 | 6.46 | 15.1 | 6.19 | 163.5 | n/a | 9 |
| 3 hr | 5.7 | 49.83 | 6.86 | 15.35 | 5.58 | n/a | n/a | 9 |
| 4 hr | 5.65 | 48.27 | 7.22 | 15.38 | 5.09 | n/a | n/a | 8 |
| 5 hr | 5.47 | 47.3 | 7.58 | 15.43 | 4.61 | 160 | n/a | 8 |
| 6 hr | 5.4 | 46.41 | 7.96 | 15.44 | 4.25 | 159.4 | n/a | 8 |
| 7 hr | 5.25 | 45.79 | 7.96 | 14.92 | 3.96 | n/a | 71 | 8 |
| Comp. Ex. 2 | | | | | | | | |
| 0 hr. | 8.68 | 52.67 | 4.89 | 14.5 | 7.51 | 169.3 | 81 | 8 |
| 1 hr | 5.02 | 45.15 | 10.31 | 13.23 | 6.56 | 164.2 | n/a | 5 |
| 2 hr | 3.99 | 37.91 | 14.33 | 12.12 | 5.87 | 161.6 | n/a | 5 |
| 3 hr | 3.45 | 31.32 | 18.63 | 11.51 | 5.18 | 160.4 | n/a | 4 |
| 4 hr | 2.75 | 24.39 | 22.39 | 10.39 | 4.44 | 159.4 | n/a | 3 |
| 5 hr | 2.17 | 19.62 | 25.35 | 9.46 | 3.97 | 157.9 | n/a | 4 |
| 6 hr | 1.75 | 14.54 | 27.5 | 8.76 | 3.4 | 154.6 | n/a | 4 |
| 7 hr | 1.22 | 9.89 | 29.39 | 7.95 | 2.88 | 153.8 | 65 | 4 |
| Comp. Ex. 3 | | | | | | | | |
| 0 hr | 6.75 | 51.73 | 5.22 | 16.52 | 7.14 | 167.3 | 75 | 7 |
| 1 hr | 6 | 48.96 | 6.311 | 16.59 | 5.59 | 163.1 | n/a | 6 |
| 2 hr | 5.69 | 46.32 | 7.21 | 16.45 | 4.58 | 162.3 | n/a | 6 |
| 3 hr | 5.41 | 43.53 | 8.09 | 16.31 | 3.77 | 159.2 | n/a | 5 |
| 4 hr | 5.28 | 41.46 | 9.16 | 16.05 | 3.23 | 158 | n/a | 5 |
| 5 hr | 4.93 | 39.34 | 9.92 | 15.94 | 2.78 | 157.5 | n/a | 5 |
| 6 hr | 4.81 | 38.66 | 10.97 | 15.82 | 2.41 | 155.8 | 73 | 5 |
| Comp. Ex. 4 | | | | | | | | |
| 0 hr | 6.69 | 51.21 | 5.33 | 16.94 | 7.07 | 167.1 | 75 | 7 |
| 1 hr | 4.24 | 35.73 | 17.46 | 13.41 | 5.02 | 162.1 | n/a | 4 |
| 2 hr | 3.09 | 24.85 | 23.79 | 11.58 | 3.88 | 158.6 | n/a | 3 |
| 3 hr | 2.08 | 16.24 | 30.87 | 10.02 | 3.17 | 155.4 | n/a | 2 |
| 4 hr | 1.45 | 10.56 | 35.21 | 9.08 | 2.38 | 153.3 | n/a | 2 |
| 5 hr | 0.89 | 6.25 | 38.81 | 8.27 | 1.88 | 152.2 | n/a | 2 |
| 6 hr | 0.53 | 2.97 | 40.84 | 7.42 | 1.43 | 149.4 | 54 | 3 |
| Comp. Ex. 5 | | | | | | | | |
| 0 hr | n/a | n/a | n/a | n/a | n/a | n/a | 75 | 7 |
| 1 hr | 3.19 | 23.83 | 26.65 | 12.3 | 3.47 | 157 | n/a | 3 |
| 2 hr | 1.75 | 12.25 | 37.71 | 10.07 | 1.93 | 153.5 | n/a | 2 |
| 3 hr | 0.93 | 5.71 | 46.19 | 8.6 | 1.49 | 150.6 | n/a | 2 |
| 4 hr | 0.41 | 1.97 | 48.2 | 7.62 | 1.02 | 148.6 | n/a | 2 |
| 5 hr | 0.17 | 0.36 | 5.68 | 7.17 | 1.11 | 146.6 | n/a | 3 |
| 6 hr | 0.12 | 0 | 50.68 | 6.9 | 0.85 | 145.3 | 57 | 4 |
| Comp. Ex. 6 | | | | | | | | |
| 0 hr | n/a | n/a | n/a | n/a | n/a | n/a | 76 | 9 |
| 1 hr | 1.81 | 13.4 | 35.97 | 10.13 | 2.24 | 155.3 | n/a | 3 |
| 2 hr | 0.8 | 5.9 | 44.97 | 8.27 | 1.27 | 153.2 | n/a | 2 |
| 3 hr | 0.39 | 2.56 | 47.89 | 7.44 | 1.11 | 151 | n/a | 2 |
| 4 hr | 0.17 | 0.95 | 50.58 | 6.91 | 0.85 | 150.8 | n/a | 2 |
| 5 hr | 0.04 | 0.13 | 50.45 | 6.74 | 0.37 | 147.8 | n/a | 4 |
| 6 hr | 0.02 | 0 | 51.44 | 6.61 | 0.3 | 146.3 | 54 | 4 |
| Comp. Ex. 7 | | | | | | | | |
| 0 hr | 5.76 | 48.75 | 6.78 | 18.1 | 6.4 | 165.7 | n/a | 9 |
| 1 hr | 2.12 | 16.84 | 32.18 | 11.28 | 2.96 | 155.4 | 76 | 4+ |
| 2 hr | 1.24 | 9.4 | 47.23 | 9.53 | 0.65 | 150.1 | 75 | 4 |
| 3 hr | 0.8 | 6.41 | 51.16 | 8.85 | 0.8 | 147.8 | 74 | 3+ |
| 4 hr | 0.67 | 5.05 | 52.5 | 8.51 | 0.9 | 146.4 | 74 | 3+ |
| 5 hr | 0.5 | 3.68 | 53.53 | 8.14 | 1.02 | 144.2 | 72 | 3+ |

Notes:
1. “n/a” means that the measurement was not made.

This single-step disproportionation was run at 240° C., 260° C. and 280° C., and with and without Ethanox® 323. The presence of Ethanox® 323 substantially accelerated disproportionation. As expected, higher temperatures provided more rapid disproportionation, but also resulted in more rapid reduction in acid number and softening point. It was not possible under any condition tested to obtain full disproportionation (abietic acid ≦0.5%) and still meet specifications for the acid number (≧155) and softening point (≧75° C.).

### EXAMPLES 1-7

These examples illustrate the results of the disproportionation reaction under different conditions with the use of sulfur and alkylphenol sulfide compounds as catalysts.

Rosin from the sources noted in Table 4 was loaded into the reactor and heated as described in the General Procedure. A nitrogen blanket was maintained over the rosin during all parts of the process. When the rosin reached 200° C., and was totally melted, the agitation was started and sulfur was added to the reactor in the amounts indicated in Table 4. The rosin was heated to the first stage holding temperature, as shown in Table 4, and held there for the indicated length of time. The addition of sulfur to the hot rosin resulted in the evolution of hydrogen sulfide gas. This was removed from the vent gas by passing it though a wet scrubber system that contained a 25% caustic solution.

After the holding period for the first stage of the reaction, the temperature was increased to the second stage temperature, as shown in Table 4, and an alkylphenol sulfide antioxidant was added in the amount shown. The alkylphenol sulfide antioxidant compounds that were tested included Ethanox® 323 (a nonylphenol sulfide oligomer available from Albemarle Chemical Co., Baton Rouge, La.). The reaction mixture was maintained at the second stage temperature with agitation, and samples were taken of the rosin mixture at the times indicated in Table 5. The samples were tested for acid number, softening point, Gardner color, and rosin acids, as described in the General Procedure. Those values are reported below in Table 5.

TABLE 4
Conditions for rosin disproportionation with sulfur
and an alkylphenol sulfide antixoidant compound.

| | | First Stage | | | Second Stage | | |
|---|---|---|---|---|---|---|---|
| | | | Catalyst & | | | Catalyst & | |
| Example | | Temp | Amount | 1^{st} Stage | Temp. | Amount | 2^{nd} Stage |
| Number | Rosin | (° C.) | (% by wt) | holding time | (° C.) | (% by wt.) | holding time |
| 1 | Rosin 2 | 240 | Sulfur @ | 2 hrs | 280 | Ethanox ® | 5 hrs |
| | | | 0.2% | | | 323 @ | |
| | | | | | | 1.5% | |
| 2 | Rosin 2 | 240 | Sulfur @ | 2 hrs | 280 | Ethanox ® | 5 hrs |
| | | | 1.0% | | | 323 @ | |
| | | | | | | 1.5% | |
| 3 | Rosin 2 | 240 | Sulfur @ | 2 hrs | 280 | Ethanox ® | 4 hrs |
| | | | 2.0% | | | 323 @ | |
| | | | | | | 1.0% | |
| 4 | Rosin 2 | 240 | Sulfur @ | 2 hrs | 280 | Ethanox ® | 4 hrs |
| | | | 1.5% | | | 323 @ | |
| | | | | | | 1.0% | |
| 5 | Rosin 1 | 240 | Sulfur @ | 2 hrs | 280 | Ethanox ® | 3 hrs |
| | | | 2.0% | | | 323 @ | |
| | | | | | | 1.0% | |
| 6 | Rosin 1 | 240 | Sulfur @ | 2 hrs | 280 | Ethanox ® | 3 hrs |
| | | | 2.5% | | | 323 @ | |
| | | | | | | 1.0% | |
| 7 | Rosin 3 | 240 | Sulfur @ | 3 hrs | 280 | Rosinox ® | 3 hrs |
| | | | 2.5% | | | 323 @ | |
| | | | | | | 1.0% | |

Notes:
1. After the second stage holding period, a vacuum of 10-20′ Hg was applied to the rosin of Example 6 for two hours at 240° C., and to the rosin of Example 7 at 240° C. for one hour, in order to strip light oils and residual hydrogen sulfide.

TABLE 5
Results of disproportionation reactions run under the conditions specified in Table 4.

| Example | | | | | | | | |
|---|---|---|---|---|---|---|---|---|
| No. and | | | | | | | | |
| sample | Rosin acids (Percent by weight) | | | | | Acid | Softening | Gardner |
| time (hr) | Neo-abietic | Abietic | Dehydro-abietic | Levo-primaric | Primaric | number | point (° C.) | Color |
| Ex. 1 | | | | | | | | |
| 1 hr | 5.24 | 50 | 11.23 | 13.64 | 6.35 | 167.2 | n/a | 7 |
| 2 hr | 5.15 | 48.13 | 12.01 | 13.81 | 5.79 | 165.7 | n/a | 7 |
| 3 hr | 1.8 | 13.41 | 37.09 | 9.78 | 2 | 157.3 | n/a | 3 |
| 4 hr | 0.79 | 5.79 | 45.85 | 7.88 | 1.08 | 154.9 | n/a | 2 |
| 5 hr | 0.24 | 1.42 | 48.42 | 6.92 | 0.91 | 151.9 | n/a | 3 |
| 6 hr | 0.07 | 0.26 | 51.51 | 6.39 | 0.7 | 151 | n/a | 3 |
| 7 hr | 0.04 | 0.07 | 50.83 | 6.35 | 0.72 | 150.1 | 53 | 4 |
| Ex. 2 | | | | | | | | |
| 1 hr | 3.66 | 34.68 | 26.52 | 10.98 | 2.88 | 165.9 | n/a | 5 |
| 2 hr | 3.51 | 33.36 | 28.07 | 10.88 | 2.61 | 163.6 | n/a | 5 |
| 3 hr | 1.37 | 10.78 | 45.5 | 8.37 | 1.06 | 158.1 | n/a | 4 |
| 4 hr | 0.74 | 5.24 | 50.52 | 7 | 0.61 | 154.5 | n/a | 3 |
| 5 hr | 0.25 | 1.45 | 52.41 | 6.2 | 0.42 | 151 | n/a | 4 |
| 6 hr | 0.09 | 0.36 | 53.3 | 5.91 | 0.4 | 149.6 | n/a | 4 |
| 7 hr | 0.06 | 0.11 | 54.36 | 5.73 | 0.32 | 148.4 | 58 | 4 |
| Ex. 3 | | | | | | | | |
| 1 hr | 1.79 | 19.2 | 50 | 7.31 | 1.03 | 165.6 | n/a | 6 |
| 2 hr | 1.76 | 15.73 | 48.5 | 7.51 | 0.82 | 164.9 | n/a | 6 |
| 3 hr | 0.28 | 1.66 | 61.48 | 5.78 | 0.16 | 155.6 | n/a | 5 |
| 4 hr | 0.13 | 0.56 | 64.54 | 5.87 | 0.07 | 154.3 | n/a | 5 |
| 5 hr | 0.06 | 0.12 | 62.88 | 5.52 | 0.07 | 153.7 | n/a | 5 |
| 6 hr | 0.06 | 0.07 | 62.04 | 5.53 | 0.06 | 155.3 | 68.5 | 6 |
| Ex. 4 | | | | | | | | |
| 1 hr | 2.52 | 24.83 | 38.3 | 8.67 | 1.99 | 166.2 | n/a | 6 |
| 2 hr | 2.48 | 22.77 | 39.84 | 8.88 | 1.75 | 166 | n/a | 5 |
| 3 hr | 0.61 | 4.37 | 55.12 | 6.75 | 0.47 | 157.5 | n/a | 5 |
| 4 hr | 0.27 | 1.6 | 56.36 | 6.03 | 0.29 | 155.2 | n/a | 4 |
| 5 hr | 0.12 | 0.49 | 57.46 | 5.71 | 0.23 | 153.2 | n/a | 4 |
| 6 hr | 0.07 | 0.13 | 58.59 | 5.59 | 0.22 | 155.1 | 65 | 5 |
| Ex. 5 | | | | | | | | |
| 1 hr | 2.56 | 23.34 | 40.24 | 8.54 | 1.34 | 167 | 78 | 6 |
| 2 hr | 2.43 | 21.43 | 42.78 | 8.39 | 1.05 | 165.9 | 80 | 5 |
| 3 hr | 0.47 | 3.17 | 56.69 | 6.28 | 0.3 | 155.8 | 70 | 4 |
| 4 hr | 0.2 | 1.04 | 59.32 | 5.7 | 0.19 | 155.2 | 66 | 4 |
| 5 hr | 0.08 | 0.22 | 60.12 | 5.36 | 0.2 | 154.2 | 67 | 5 |
| Ex. 6 | | | | | | | | |
| 1 hr | 2.11 | 19.27 | 45.8 | 7.54 | 1.09 | 166.8 | 79.5 | 6 |
| 2 hr | 1.95 | 17.61 | 47.14 | 7.46 | 0.9 | 165.7 | 79 | 5 |
| 3 hr | 0.36 | 2.4 | 59.88 | 5.6 | 0.26 | 156.6 | 70.5 | 5 |
| 4 hr | 0.16 | 0.84 | 61.39 | 5.15 | 0.16 | 155.1 | 70.5 | 5 |
| 5 hr | 0.07 | 0.2 | 62.51 | 4.91 | 0.08 | 154.5 | 68.5 | 5 |
| 6 hr | 0.09 | 0.12 | 69 | 5.22 | 0.17 | 156.5 | 76 | 7 |
| 7 hr | 0.09 | 0.12 | 67.69 | 5.05 | 0.06 | 157.9 | 78 | 11 |
| Ex. 7 | | | | | | | | |
| 3 hr | 0.83 | 7.08 | 65.14 | 6.28 | 0.29 | 165.5 | n/a | 7 |
| 4 hr | 0.1 | 0.37 | 70.55 | 5.46 | 0.01 | 158.5 | n/a | 7 |
| 5 hr | 0.07 | 0.11 | 70.84 | 5.42 | 0.06 | 156.6 | n/a | 7 |
| 6 hr | 0.07 | 0.05 | 70.49 | 5.75 | 0.1 | 156 | n/a | 8 |
| 7 hr | 0.08 | 0.07 | 70.86 | 5.37 | 0.08 | 156.8 | 87.5 | 11 |

Notes:
1. ”n/a” means that the measurement was not made.

From the results shown in Table 5, it is seen that when a sulfur level of 2.5% and a level of alkylphenol sulfide antioxidant of 1%, a fully disproportionated rosin was obtained. Subsequent vacuum treatment at 240° C. for the final product increased the acid number and the softening point as well as the level of dehydroabietic acid. The final disproportionated rosin is a very high quality product with high acid number (≧155), softening point (≧75° C.), dehydroabietic acid level (≧50% by wt., and in some instances ≧62% by wt.), and low abietic acid level (≦0.5%, and in some instances ≦0.1%).

All references cited in this specification, including without limitation all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinency of the cited references.

In view of the above, it will be seen that the several advantages of the invention are achieved and other advantageous results obtained.

As various changes could be made in the above methods and compositions by those of ordinary skill in the art without departing from the scope of the invention, it is intended that all matter contained in the above description shall be interpreted as illustrative and not in a limiting sense. In addition it should be understood that aspects of the various embodiments may be interchanged both in whole or in part.

What is claimed is:

1. A method of producing fully disproportionated rosin, the method comprising:
(a) contacting a rosin with sulfur to form a partially disproportionated rosin; and
(b) contacting the partially disproportionated rosin with an alkylphenol sulfide compound having the structure 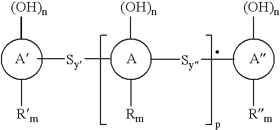
where:
each of A, A′ and A″ is independently an aryl;
each n is independently 1, 2, or 3;
each of y′ and y″ is independently 0, 1, 2, or 3;
the sum of m and n on each aryl is 1, 2, 3, 4, or 5;
p is an integer from 0 to 100 inclusive; and
each of R, R′ and R″ is independently a hydrocarbon group,
to form a fully disproportionated rosin.

2. The method according to claim 1, wherein A, A′ and A″ are the same and are selected from phenyl, naphthyl, or anthracyl.

3. The method according to claim 2, wherein each of R, R′ and R″ is independently a substituted or unsubstituted alkyl, or cycloalkyl, which if substituted, has substituent groups selected from cycloalkyl, aryl, or alkaryl.

4. The method according to claim 2, wherein each of R, R′ and R″ is independently an alkyl of from 1 to 22 carbon atoms.

5. The method according to claim 2, where:
A, A′ and A″ are each phenyl;
each m and each n is 1;
each of y′ and y″ is independently 0, 1, 2, or 3;
p is 0, 1, or 2; and
each R, R′ and R″ is nonyl.

6. The method according to claim 1, wherein the step of contacting a rosin with sulfur to form a partially disproportionated rosin comprises contacting the rosin with sulfur at a first temperature and for a first period of time.

7. The method according to claim 6, wherein the rosin is tall oil rosin, wood rosin, gum rosin, crude rosin containing materials, or a mixture of any two or more of these materials.

8. The method according to claim 6, wherein the rosin is tall oil rosin, wood rosin, or gum rosin.

9. The method according to claim 6, wherein the amount of sulfur is between about 0.5% and about 10%, by weight based on the weight of the rosin, and where the sulfur is contacted with the rosin for a period of from about 0.5 hrs to about 10 hrs at a temperature that is between about 200° C. and about 325° C.

10. The method according to claim 6, wherein the amount of sulfur is between about 1% and about 5%, by weight based on the weight of the rosin, and where the sulfur is contacted with the rosin for a period of from about 1 hrs to about 5 hrs at a temperature that is between about 225° C. and about 275° C.

11. The method according to claim 6, wherein the amount of sulfur is between about 2% and about 3%, by weight based on the weight of the rosin, and where the sulfur is contacted with the rosin for a period of from about 1 hrs to about 3 hrs at a temperature that is between about 230° C. and about 250° C.

12. The method according to claim 6, wherein the amount of sulfur is about 2.5%, by weight based on the weight of the rosin, and where the sulfur is contacted with the rosin for a period of from about 2 hrs to 3 hrs at a temperature that is about 240° C.

13. The method according to claim 6, wherein the amount of the alkylphenol sulfide compound is between about 0.1% and 15% by weight based on the weight of the rosin, and the compound is contacted with the partially disproportionated rosin for a period of from about 1 hour to about 10 hours at a temperature that is between about 200° C. and 350° C.

14. The method according to claim 6, wherein the amount of the alkylphenol sulfide compound is between about 0.5% and 1.5% by weight based on the weight of the rosin, and the compound is contacted with the partially disproportionated rosin for a period of from about 2 hours to about 5 hours at a temperature that is between about 240° C. and 300° C.

15. The method according to claim 6, wherein the amount of the alkylphenol sulfide compound is about 1% by weight based on the weight of the rosin, and the compound is contacted with the partially disproportionated rosin for a period of about 3 hours to 4 hours at a temperature that is about 280° C.

16. The method according to claim 1, wherein the fully disproportionated rosin has a concentration of abietic acid of equal to or less than 0.5% by weight, a concentration of dehydroabietic acid of equal to or more than 45% by weight, an acid value of equal to or greater than 150 mg KOH/g rosin, and a softening point of equal to or greater than 75° C.

17. The method according to claim 1, wherein the fully disproportionated rosin has a concentration of abietic acid of equal to or less than 0.1% by weight, a concentration of dehydroabietic acid of equal to or more than 52% by weight, an acid value of equal to or greater than 155 mg KOH/g rosin, and a softening point of equal to or greater than 75° C.

18. The method according to claim 1, wherein the partially disproportionated rosin has an abietic acid concentration that is lower than the abietic acid content of the rosin, but is above about 1% by weight.

19. The method according to claim 1, wherein the partially disproportionated rosin has an abietic acid concentration that is lower than the abietic acid content of the rosin, but is above about 5% by weight.

20. The method according to claim 1, wherein the partially disproportionated rosin has an abietic acid concentration that is lower than the abietic acid content of the rosin, but is above about 10% by weight.

21. The method according to claim 6, further comprising removing hydrogen sulfide and/or light oils during steps (a) and/or (b).

22. The method according to claim 21, wherein light oils and residual sulfur are removed by steam stripping or by applying a vacuum to the rosin.

23. The method according to claim 6, further comprising bleaching the fully disproportionated rosin.

24. The method according to claim 6, wherein steps (a) and (b) are carried out under a nitrogen gas atmosphere.

25. The method according to claim 1, wherein the step of contacting a rosin with sulfur is carried out before the step of contacting the partially disproportionated rosin with an alkylphenol sulfide compound.

26. A fully disproportionated rosin that is made by the method of claim 1.
